(19) United States
(12) Patent Application Publication
(10) Pub. No.: US 2006/0086199 A1
(43) Pub. Date: Apr. 27, 2006

(54) Throttle cable disconnection apparatus and method

(75) Inventors: Frank Dircks, Bartonville, IL (US); Alan C. Branch, Bartonville, IL (US)

Correspondence Address: HUSCH & EPPENBERGER, LLC, 190 CARONDELET PLAZA, SUITE 600, ST. LOUIS, MO, 63105-3441, US

(73) Assignee: Reduce Your Speed, Inc., Bartonville, IL (US)

(21) Appl. No.: 10/971,431

(22) Filed: Oct. 22, 2004

(51) Int. Cl. F16C 1/22

(52) U.S. Cl. 74/502.6

(57) ABSTRACT

A remotely activated throttle disconnector for a motor vehicle that has a throttle cable, the throttle having a conduit and a wire within the conduit and disposed to slide axially through the conduit such that a mechanical tractive force applied to a first end of the cable is transferred to a second end of the cable. The disconnector is comprised of a housing with a first end and a second end, each of the ends having a mount for an end of a section of the conduit of the throttle cable and each of the ends having a through hole. The through hole allows passage of an end of a section of the wire of the throttle cable therethrough. An electromagnet is disposed in the housing to slide axially therein. The electromagnet connects to the wire end of one section of the throttle cable. A passive plate is disposed in the housing to slide axially therein. The passive plate connects to the wire end of another section of the throttle cable. The electromagnet and the passive plate have an engaged position and a disengaged position. The engaged position transfers tractive force from a first section of the cable to the second section of the cable. The electromagnet and the plate are in the engaged position when the electromagnet is energized, disengaged when the electromagnet is de-energized. A tractive force is only transferred through the disconnector when the electromagnet is energized.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to automobile control components, particularly safety components, and most particularly throttle safety controls and enabling and disenabling devices.

2. Related Art

Tens of thousands of people are killed in motor vehicle accidents in America every year. Hundreds of thousands more are injured. A disproportionate percentage of these injuries are caused by persons driving at excessive speeds. In particular, criminal high speed chases, speeding in stolen cars and street racing are excessively hazardous.

There is a clear need in the automotive arts for a safety system to control vehicle speeds in a selected manner by persons other than the driver; for example, the owner of a stolen vehicle, a police office in pursuit of a speeding criminal, or a sober person aware of a drunken driver.

Prior attempts to establish such a vehicle disablement system include U.S. Pat. No. 6,715,395 to Heibel, which discloses a method of shooting out vehicle tires, U.S. Pat. No. 5,533,589 to Critzer which discloses a remotely activated fuse for disabling the vehicle fuse box to shut down its electrical systems, U.S. Pat. No. 5,861,799 to Szwed disclosing a remote fuel pump shut off. U.S. Pat. No. 5,513,244 to Joao et al. also discloses a remote fuel pump deactivation device. These remote shut off devices share multiple problems. First, shutting off all vehicle systems, such as the fuse in the Critzer reference, shuts off other control systems besides the throttle. Power braking and power steering are lost, which creates an equally risky situation.

Fuel shut off systems lack a sufficient response time. Moreover, fuel system shut off devices require integrated systems that do not lend themselves to retrofitting in an economical way. The prior art systems are also complex and expensive.

There is a need in the art for a vehicle disabling device and system that selectively deactivates only the throttle, provides an immediate response, and does not also deactivate other safety related systems such as steering and braking. There is a continuing need in the art for economy, durability, simplicity, and retrofitting capability.

### SUMMARY OF THE INVENTION

In both carbureted and fuel injected motor vehicles, the throttle control connects the foot pedal to the gas/air mixture via a simple mechanical cable. The cable includes a flexible conduit. Inside the conduit a flexible wire is disposed to slide axially through it. The operator's foot pedal is mechanically linked at one end of the cable. The cable is mounted to the foot pedal such that depressing the pedal pulls the wire axially through the conduit. At a second end of the cable, the conduit is mounted to a throttle control device. This may be a carburetor, or in fuel injected systems it may be an air intake valve. Typically the end of the conduit is fixedly mounted and the wire extending from the end of the conduit is attached to a lever that controls the air intake valve. The traction applied by the operator at the foot pedal at the first end of the cable, is transferred to the air intake valve at the second end of the cable when the wire is drawn into the conduit at the second end of the cable, thereby pulling the lever. The other general aspects of throttle control are well known.

The most immediately responsive and simple way to disconnect the throttle of a motor vehicle would be to simply interrupt this mechanical linkage. The present invention does just that.

The device of the present invention is installed inline with a throttle cable, dividing the cable into a first section and second section. The first section remains mechanically linked to the operator's control, usually a foot pedal. The second section remains linked to the air intake valve or other throttle control lever. The device of the present invention has an engaged position, wherein the tractive force applied by the operator is transferred through the device and to the air valve control lever as before for normal operation. In a disconnected position, the device of the present invention interrupts the wire running through the cable in order that an operator's tractive force applied to the first section of the cable to wire increase speed ends at the device and is not transferred to the valve control lever.

The throttle disconnector of the present invention may be installed and used with automobiles, trucks, boats, motorcycles or any other motor vehicle whose speed is controlled by a throttle having a mechanical linkage.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a schematic depiction of the system of the present invention;

FIG. 2 is a block diagram of the system of the present invention; and

FIG. 3 is a cut away side view of the throttle disconnect device of the present invention; and

FIG. 4 is a side view of a mounting screw for electromagnet.

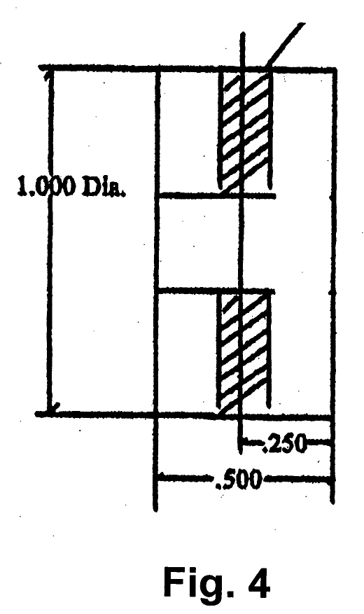

### DETAILED DESCRIPTION OF THE PREFERRED EMBODIMENTS

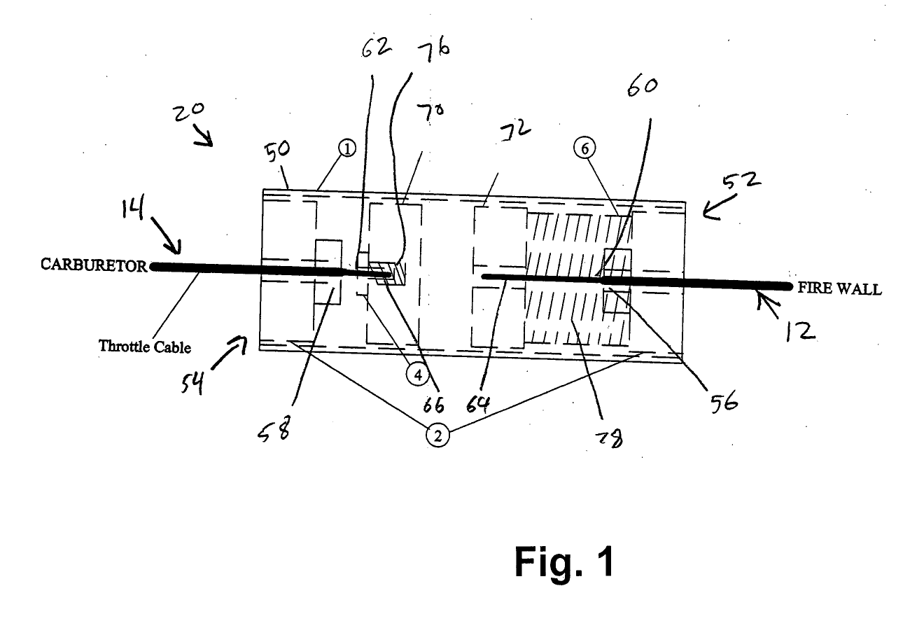

FIG. 1 is a schematic diagram of the system of the present invention. Mechanical throttle cable 10A and 10B is normally a single continuous line. After installation of the present invention either as original equipment or a retrofit, it is divided into a first section 12 and a second section 14. The first section is comprised of a first conduit section with a first wire section inside of it. The second section is comprised of second conduit section with a second wire inside of it. The first throttle cable section 12A and 12B are mechanically linked with and operated by foot pedal 16. The second section of the throttle cable 14 is operatively attached and linked with a carburetor or air intake valve of the fuel injection system 18.

FIG. 1 depicts the throttle disconnector 20 of the present invention twice. At the top, 20A, it is depicted in its engaged position for a normal operation. At the bottom of FIG. 1, the throttle cable disconnector of the present invention 20B is depicted and disconnected. Each view is a cutaway side view. In the engaged position depicted in 20A, an internal electromagnet 22A is energized so that its tractive force brings it into contact with the rod or plate 24A. In the disengaged position, depicted at 20B, magnet 22B is de-energized and consequently disconnected from metal plate or rod 24B. The strength of the electromagnet 22 is selected such that the tractive force connecting it with metal plate or rod 24 is sufficient to maintain that attachment throughout the entire range of foreseeable tractive forces mechanically applied by a user through the foot pedal. Also depicted in FIG. 1 is a radio frequency transmitter 26 used as an actuator for the present invention and a radio frequency receiver 28. Also schematically depicted are electric connections 30 between the throttle disconnector 20 and the RF receiver 28.

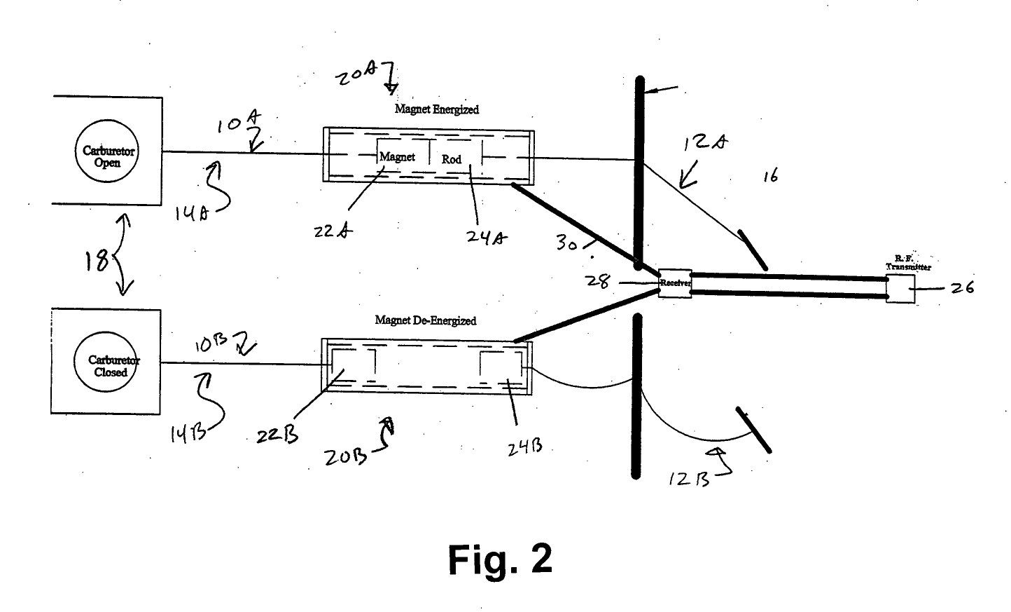

FIG. 2 is a schematic diagram of the wiring of the present invention. Power is provided to the electromagnet so that it may be energized to engage the throttle disconnector 20 for normal operation. Battery 32 is connected to the receiver 28. The ignition 34 is connected to the electromagnet 22. The electromagnet 22 is also grounded 36 which ground through the relay 38. An optional cruise control module 40 may be included.

In operation, starting the ignition of the vehicle energizes the electromagnet, engaging the device for normal operation.

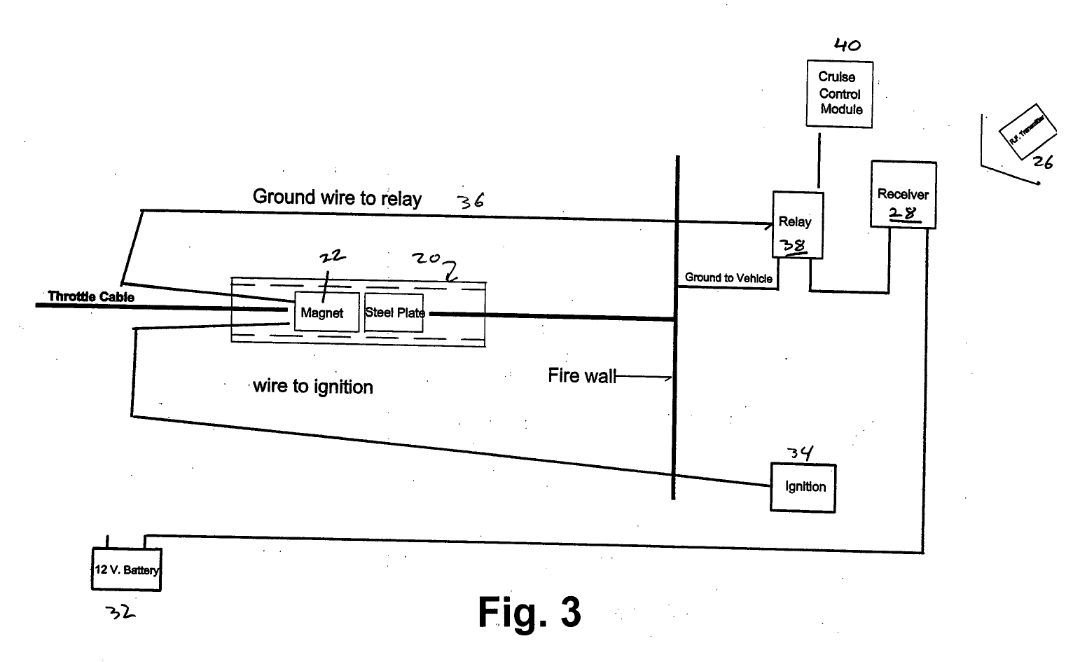

FIG. 3 is a cut away side view of the throttle disconnector of the present invention. A housing 50 has a longitudinal axis. The longitudinal axis is substantially parallel with the axis of the throttle cable near the points of connection of the throttle cable with the throttle disconnector 20. The housing has a first end 52 and a second end 54. The first end 52 is constructed and adapted to engage the first section of the throttle cable 12. The second end 54 is constructed and adapted to the second of the throttle cable 14. The throttle cable engagements at both ends of the housing 50 include cable conduit seats 56, 58. At these seats the ends of the first cable section 12 conduit and second cable section 14 conduit are attached to the ends 52 and 54 of the housing 50 such that they do not move after installation. The ends of the housing 52 and 54 also include through holes 60 and 62. These through holes are dimensioned to allow passage therethrough for the throttle cable wires. When the device is installed these wires 64 and 66 are attached to the operative moving parts of the throttle disconnector 20.

Inside the housing and disposed to slide axially through it are electromagnet 70 and a metal rod or plate 72. The electromagnetic plate 70 and the passive plate 72 are adapted to securely anchor throttle cable wire ends. In the depicted embodiment, this attachment is by threaded bolt 76.

Spring 78 biases the passive plate 72 into contact with the electromagnet 70 when the vehicle is off. The spring counteracts the effect of the idle spring on a carbonator or air intake valve linkage that is standard on motor vehicles. The standard linkage spring biases the second section of the throttle cable wire away from the throttle disconnector, and hence biases the electromagnet 70 away from passive plate 72 towards disconnection. Expansion spring 78 counteracts the standard linkage springs, keeps the electromagnet 70 and passive plate 72 engaged together when vehicle is off, and allows the throttle disconnector 20 to be in the engaged and operative position when the vehicle is started.

In operation, an electronic activation signal is received at receiver 26 and electrical wires 30 connected to the electromagnet 70 are de-energized. When the electromagnet is de-energized, the tractive force between the electromagnet 70 and passive plate 72 ends and they are separable. In the mode of normal operation, the electromagnet 70 is energized and its tractive force draws it into contact with the passive plate 72. In this engaged state, electromagnet and passive plate move as a single unit. Accordingly, when an operator applies a mechanical tractive force to the throttle cable, the tractive force pulls the first section of throttle wire 60 towards the foot pedal, which is to the right in FIG. 3. The engaged connection between the electromagnet 70 and passive plate 72 transfers the tractive force through themselves and to the second section of the throttle wire. The housing 50 is sufficiently long, and its internal space is sufficient long, so that a normal range of motion for the throttle is maintained. When the device is the engaged position the tractive force is simply transferred on to the second throttle cable section 14, so that its engagement with the air valve works normally.

When the device is activated, the electro magnet 70 is de-energized and it separates from the passive plate 72. Thereafter, when the operator of the vehicle depresses the foot pedal and imparts a mechanical tractive force to the first section throttle wire 60, that force pulls the passive plate 72 toward the foot pedal which is to the right in FIG. 3. However, because the passive plate is disconnected from the electromagnet 70, the force is not transferred on to the second section of the throttle wire 62. The second section of the throttle cable 14, and the air valve to which it is connected, remain in their standard idle position, as if there was no pressure whatsoever on the foot pedal. Accordingly, the vehicle coasts and ultimately rolls to a stop. One advantage of the present invention is that other safety control systems such as power steering and power braking remain unaffected by the mechanical disconnection of the throttle linkage. Accordingly, the operator of the vehicle can control the vehicle in a safe manner as it coasts to a stop.

Actuation of the device is through energizing and de-energizing the electromagnet. In the depicted embodiment, energizing the magnet places the device in its engaged position for normal operation. Control of the energization of the electromagnet is electronic according to known methods. The magnet is de-energized by curtailing electric power to it. Actuation of the device is by an electronic signal to the circuit energizing the magnet to re-connect. In the depicted embodiment, the power circuit is of course hard wire and so is the signal circuit between an actuator and the power circuit. In the depicted embodiment, the signaling actuator is a radio frequency receiver, which is configured to signal a deactivation of the electromagnet upon receipt of a radio frequency transmitter. It is within the scope of the present invention that the signal to energize or de-energize the electromagnet may be transmitted and received according to any known signal processing technique, including but not limited to a hard wiring, a radio frequency transmission, infrared transmission, laser transmission or any other electromagnetic wave.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A remotely activated throttle disconnector for a motor vehicle having a throttle cable, the throttle having a conduit and a wire within the conduit and disposed to slide axially through the conduit such that a mechanical tractive force applied in a first end of the cable is transferred to a second end of the cable, said disconnector comprising:
a housing, said housing having a first end and a second end, each of said ends having a mount for an end of a section of the conduit of the throttle cable and each of said ends having a through hole, said through hole being dimensioned to allow passage of an end of a section of the wire of the throttle cable therethrough, and said housing having a longitudinal axis, said longitudinal axis being substantially parallel with the throttle cable;
an electromagnet, said electromagnet disposed in said housing to slide axially therein, said electromagnet being adapted to connect to the wire end of one section of the throttle cable;
a passive plate, disposed in said housing to slide axially therein, said passive plate being adapted to connect to the wire end of another section of the throttle cable;
said electromagnet and said passive plate having an engaged position and a disengaged position, said engaged position transferring tractive force from a first section of the cable to the second section of the cable;
wherein said electromagnet and said plate are in said engaged position when said electromagnet is energized such that a tractive force may be transferred through said throttle disconnector, and wherein said electromagnet and plate are disengaged when said electromagnet is de-energized such that a tractive force is not transferred through said disconnector.

2. The throttle disconnector of claim 1 further comprising a spring, said spring being disposed in said housing to bias said passive plate and said electromagnet together.

3. The throttle disconnector of claim 1 wherein said electromagnet is activated via a hardwire switch.

4. The throttle disconnector of claim 1 wherein said electromagnet is activated via an actuator selected from the group consisting of:
the radio frequency device, an infrared device, a microwave device, and a laser device.

5. The throttle disconnector of claim 1 further comprising a radio frequency signal receiver, said receiver being in operative communication with said electromagnet to actuate said electromagnet.

6. A method of installing a throttle disconnector comprising:
separating a throttle cable into a first section and a second section;
attaching a conduit end of said first section to a first end of a housing, said housing enclosing an electromagnet and a passive plate, said electromagnet and passive plate being disposed to slide axially within said housing;
fixing a first wire of said first section of said throttle cable to said passive plate within said housing;
attaching a conduit end of said second section of said throttle cable to a second end of said housing;
fixing a second wire of said second section of said throttle cable to an electromagnet within said housing, such that when said electromagnet is energized, a tractive force supplied to said first section of said throttle cable is transferred through said throttle disconnector to said second section of said throttle cable and such that when said electromagnet is deactivated a tractive force supplied to said first section of said throttle cable is not transferred to said second section of said throttle cable.

7. The method of claim 6 further comprising a spring, disposing in said housing to bias said passive plate and said electromagnet together.

8. The method of claim 6 wherein said electromagnet is configured to be activated via a hardwire switch.

9. The method of claim 6 further comprising wiring said electromagnet to be activated via an actuator selected from the group consisting of:
the radio frequency device, an infrared device, a microwave device, and a laser device.

10. The method of claim 6 further comprising operatively connecting a radio frequency signal receiver, to be in operative communication with said electromagnet to actuate said electromagnet.

11. The method of claim 6 wherein said installation is a retrofit.

12. The method of claim 6 wherein said installation is in an automobile.

13. The method of claim 6 further comprising powering said electromagnet with a battery in said automobile.

14. The method of claim 6 further comprising a mounting screw for fixing said second wire to said electromagnet.

15. A method of assembling a throttle disconnector for a motor vehicle comprising:
fabricating a housing having an open internal space;
dimensioning an electromagnet and a passive plate such that they may slide axially along said open space within said housing;
enclosing said electromagnet and said passive plate within said housing;
forming a throttle cable conduit mount in each of a first end and second end of said housing;
creating a through hole in each of said first end and said second end of said housing, said through hole being arranged and configured to allow passage therethrough of a first end and a second end of a wire of said throttle cable;
providing a wire fixation on an outer facing surface of each of said electromagnet and said passive plate.

16. The method of claim 15 further comprising the step of disposing a spring within said housing, said spring biasing said electromagnet and said passive plate together.

17. The method of claim 15 wherein said step of fixing said second end of said wire of said throttle cable to said electromagnet is with a screw mount.

18. The method of claim 15 further comprising providing a wire lead on said electromagnet, said wire lead being adapted for connection to a power source external to said throttle disconnector.

19. The method of claim 18 wherein said wire lead is further adapted to receive switching signals from an external source for an energizing and deenergizing said electromagnet.
